(19) United States
(12) Patent Application Publication
(10) Pub. No.: US 2017/0012418 A1
(43) Pub. Date: Jan. 12, 2017

(54) Ringed Tubular Sheath Comprising an Internal Clamping Means

(71) Applicant: DELFINGEN FR-ANTEUIL, S.A., Anteuil (FR)

(72) Inventors: Sebastien ROUX, Dambenois (FR); Michael GUIHOT, Sainte-Marie (FR); Patrick VOIDEY, Autechaux (FR); Matthieu BERNICOT, Baume-les-Dames (FR)

(21) Appl. No.: 15/116,396

(22) PCT Filed: Feb. 6, 2015
(86) PCT No.: PCT/IB2015/000117

§ 371 Date: Aug. 3, 2016

(30) Foreign Application Priority Data
Feb. 6, 2014 (FR) 14/00337

(51) Int. Cl. H02G 3/04; B29C 43/36; B29C 43/02

(52) U.S. Cl. CPC H02G 3/0468; B29C 43/027; B29C 43/021; B29C 43/36; B29C 2043/023; B29C 2043/3602; B29L 2023/18

(57) ABSTRACT

The invention relates to a ringed tubular sheath including at least one internal means (5) for clamping a tube (11) in particular, and more specifically a smooth tube, located inside said sheath, said sheath being unique in that at least one flexible area (8) is associated with the internal clamping means (5). The invention also relates to a method for manufacturing such a sheath, and to a method for maintaining a ringed tubular sheath on a tube (11), in which: a ringed tubular sheath is used according to the invention; the flexible area(s) (8) are controlled such as to the deform the sheath; the tube (11) is inserted in the ringed tubular sheath, and the flexible area(s) (8) are then released.

The invention relates to a ringed tubular sheath comprising an internal clamping means which can be used in particular to clamp a tube located inside a sheath. The invention also relates to a method for manufacturing such a sheath and to a method for maintaining a ringed tubular sheath on a tube.

### BACKGROUND OF THE INVENTION

Using ringed tubular sheaths to protect electrical cables is well known.

For example, the international application published under number WO 97/32379 describes a circular ringed tubular sheath closing on itself to enclose electrical wires or cables.

The European patent application published under number EP 268 869 also proposes (see in particular FIG. 3 thereof) a ringed tubular sheath consisting of two shells fitting into each other to protect electrical cables.

The European patent application published under number EP 952 652 concerns a heart-shaped ringed tubular sheath designed to contain cables.

The international application published under number WO 2008/003485 relates to a ringed tubular sheath consisting of two shells connected by a hinge such that one of them can overlap the other to close the sheath.

All of these ringed tubular sheaths are designed to contain electrical wires or cables.

Furthermore, the international application published under number WO 2006/096896 proposes a corrugated electrical installation tube containing protuberances inside it.

The international application published under number WO 02/087048 concerns a longitudinally split ringed tubular sheath comprising a flexible longitudinal strip intended either to produce a hinge effect or allow easier opening of the sheath (first embodiment), or to prevent the aggression which may be caused by the slit associated with the grooves (second embodiment).

The international application published under number WO 2005/117222 concerns a conductor guiding device consisting of axially interconnected flexible corrugations. To obtain stiffening of the device, the flexible corrugations are reinforced by stiffening bars positioned between them, each stiffening bar located in the hollow formed on the outside, between the tops of two adjacent corrugations.

French patent application no. 2 935 556 relates to a ringed tubular sheath sealed by a sealing means.

No document of the state of the art considered alone or in combination with another document indicates in particular how it would be possible both to easily insert a tube in a ringed tubular sheath and to hold it in place there firmly.

### SUMMARY OF THE INVENTION

The main object of the invention is to be able to use a ringed tubular sheath with a tube, in particular a smooth tube, realising easy assembly of the tube and the sheath and then firm holding of the sheath on the tube.

According to the invention, this object is achieved by means of a ringed tubular sheath comprising at least one internal clamping means intended in particular to firmly hold the sheath in place on the tube inserted into the sheath, clamping the tube, this sheath having the particularity that at least one flexible area is associated with the internal clamping means.

The method also relates to a method of manufacturing such a ringed tubular sheath as well as a method of maintaining a ringed tubular sheath on a tube.

Other characteristics and advantages of the invention will now be described in detail in the following disclosure which is given with reference to the appended figures, which represent schematically:

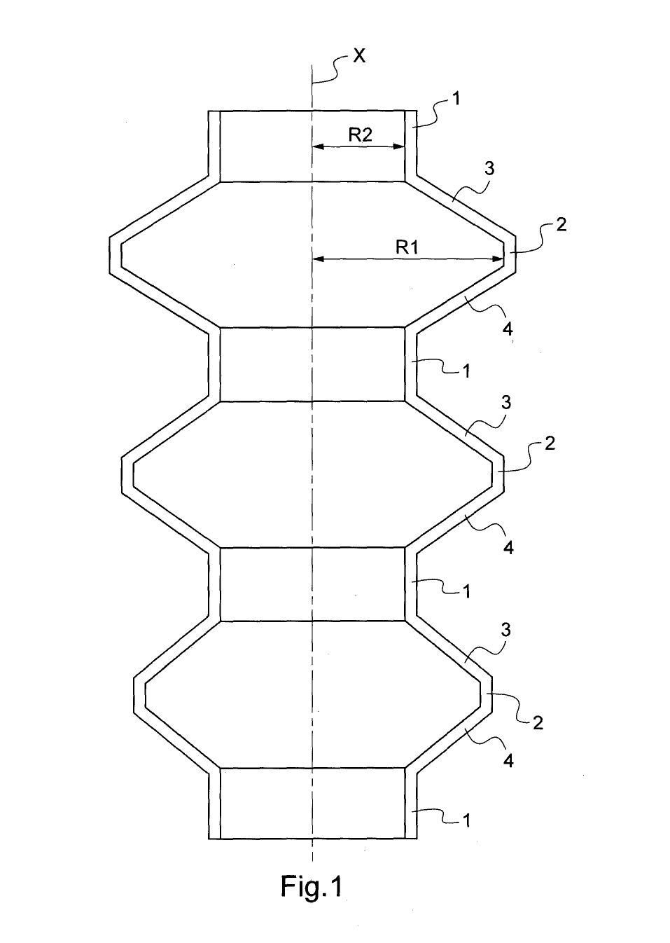

FIG. 1: a conventional ringed tubular sheath in longitudinal section;

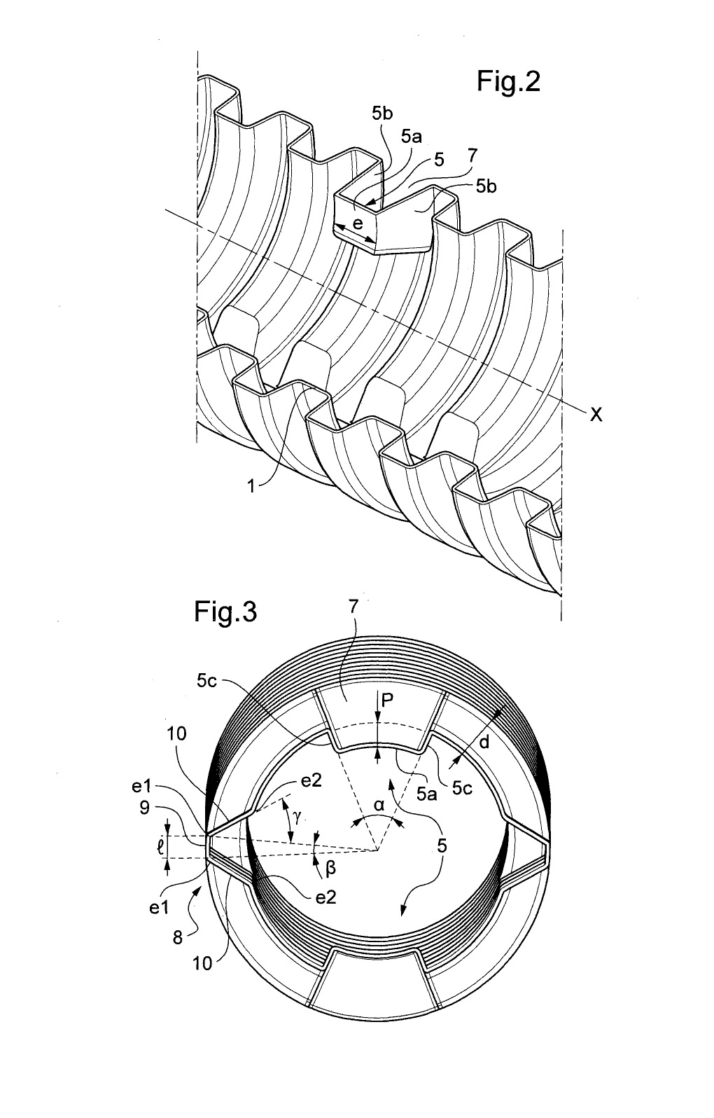

FIG. 2: the inside of a ringed tubular sheath according to the invention, in perspective and in section;

FIG. 3: the ringed tubular sheath of FIG. 2, in sectional front view;

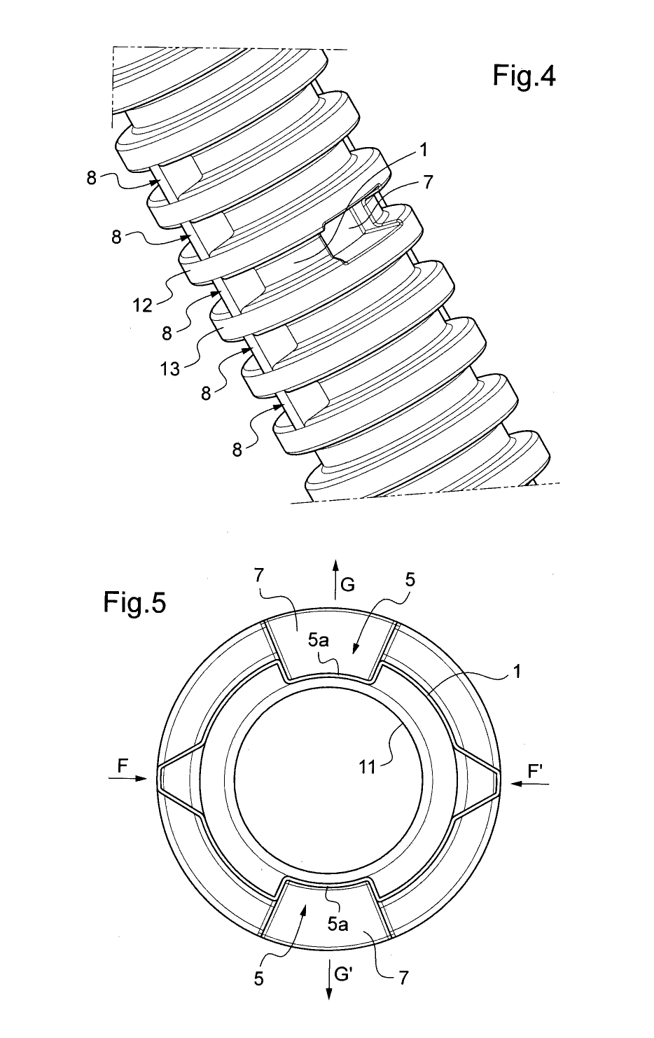

FIG. 4: a tubular sheath according to the invention, in side view;

FIG. 5: a tubular sheath according to the invention containing a smooth tube, in section;

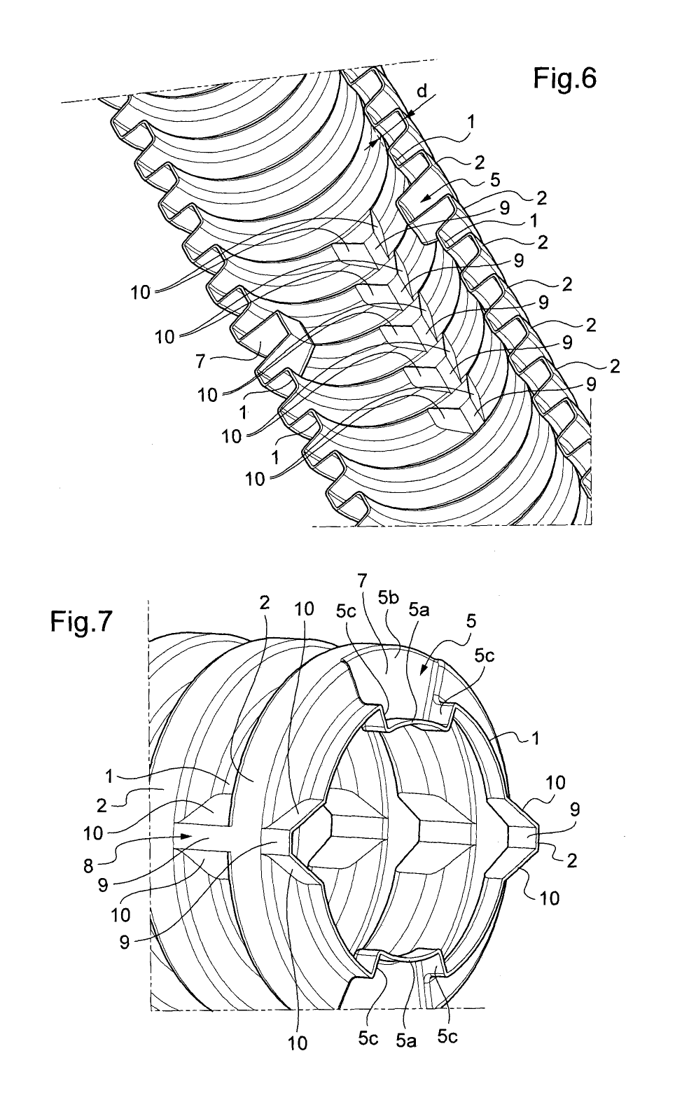

FIG. 6: the inside of the tubular sheath according to the invention of FIG. 4, after rotation around its longitudinal axis and in section; and

FIG. 7: a tubular sheath according to the invention, in sectional side view.

### DETAILED DISCLOSURE OF THE INVENTION

In this disclosure, the term “ring” refers to a hollow cylinder section, circular or not, and the term “ringed tubular sheath” refers to a plurality of inner ring/outer ring pairs extending along a longitudinal axis and connected by substantially radial walls, that is to say walls substantially perpendicular to the longitudinal axis of the sheath.

A substantially cylindrical ringed tubular sheath of conventional type is shown in FIG. 1 in which it can be seen that each outer ring 2 is connected to an inner ring 1 by two walls 3,4 inclined relative to a plane perpendicular to the longitudinal axis X, two adjacent inclined walls 3, 4 having opposite inclinations.

In other types of conventional ringed tubular sheaths, the walls 3,4 are more “radial” in that they are more perpendicular to the longitudinal axis X of the sheath.

A corrugation is defined as being composed of an outer ring 2 and two radial walls 3,4 to which this outer ring 2 is connected.

In a ringed tubular sheath, each corrugation 2, 3, 4 is thus connected to the one which precedes it or follows it by an inner ring 1 as defined above.

FIG. 2 shows a ringed tubular sheath according to the invention. As can be seen in this figure, the tubular sheath comprises an internal clamping means 5.

According to one embodiment of the invention, this internal clamping means 5 consists of a part of an inner ring 1 forming or comprising a protuberance or lug projecting towards the inside of the sheath. This projection may have a substantially frusto-pyramidal shape comprising a top 5a, two lateral sides 5b which may be radial and two longitudinal sides 5c (visible in FIG. 3).

The top 5a may form an arc of a circle in a plane perpendicular to the longitudinal axis X of the sheath, the centre of this arc then being able to be the projection of the axis X on said perpendicular plane.

The clamping means 5 can be formed by displacing material, for example during moulding of the sheath, and its counter-form thus appears on the outside of the sheath as a hollow 7.

As can be seen in FIG. 3, the depth (or in the event of variability, the mean depth) p of the lug or protuberance 5, measured from the inner wall of the inner ring 1 which carries it, can represent between 0% and 100% of the difference d between the distance R1 (see FIG. 1) between the outer ring 2 and the axis X and the distance R2 between the inner ring 1 and the axis X, these distances being measured from the inner walls of the rings 1,2 and being radii if the sheath is circular. Preferably, the depth d is between 30 and 70% of the difference d; more preferably still, it is equal to approximately 50% of the difference d.

The angle (or in the event of variability, the mean angle) α formed between the straight lines connecting the lateral sides 5c of the lug 5 to the longitudinal axis X in a plane perpendicular to this longitudinal axis X is generally 10 to 90 degrees, preferably between 40 and 60 degrees and commonly around 45 degrees (as is the case in FIG. 3).

The protuberance 5 has a thickness e which can be seen in FIG. 2, that is to say a length along the axis X, which may be equal to or smaller than that of the inner ring 1 in question.

According to an advantageous embodiment shown in FIG. 3, the ringed tubular sheath according to the invention comprises two clamping means 5, preferably the same and preferably located face to face, that is to say symmetrically opposite with respect to the longitudinal axis X.

FIG. 4 shows another advantageous embodiment in which at least one flexible area 8 is formed in correspondence with the one or more internal clamping means 5 (whose counter-form 7 can be seen in FIG. 4), so as to allow localised deformation of the sheath, this deformation making it possible to reduce or negate the clamping force exerted by the one or more internal clamping means 5.

Thus, as can be seen in FIG. 5, if a user compresses the sheath in the direction of the arrows F and F′, the sheath deforms in the direction of the arrows G and G′, which has the effect of reducing or even negating the pressure exerted by the facets) 5a of the clamping means 5 on a tube 11 located inside the sheath. This results in the possibility for the tube 11 to slide inside the sheath.

Indeed, in the normal state, the internal clamping means 5 blocks the tube 11 and thus prevents any longitudinal translation of it within the sheath. Due to the cooperation of the flexible area 8 with the clamping means 5 with which it is associated, when the user compresses the sheath in the direction of the arrows F and F′, particularly between his fingers, the sheath assumes a substantially oblong shape which distances the mean of clamping 5 from the outer wall of the tube 11 and therefore releases it.

This implies that the relative dimensions of the sheath and the tube 11 as well as the depth p of the clamping means 5 are appropriate. Indeed, when the compression exerted by the user shrinks the sheath along the line connecting the arrows F and F′, firstly there must remain a certain clearance between the inner walls of the inner rings 1 of the sheath and secondly the clamping means must move aside sufficiently in the direction of the arrow(s) G (and G′) to release their grip on the tube 11. The tube is then free to move longitudinally inside the sheath.

As can be seen by referring again to FIG. 4, it is possible to provide more flexible areas 8, for example three or five, preferably symmetrically distributed axially on either side of the one or more internal clamping means 5.

Furthermore, it is advantageous to provide several internal clamping means 5, for example three, five or seven, distributed along the longitudinal axis of the sheath and preferably spaced symmetrically in a plane perpendicular to the axis X.

It is also possible to group them in pairs of internal clamping means 5 which are symmetrically opposed with respect to the longitudinal axis X of the sheath.

In addition, for each pair of internal clamping means 5, it is desirable that each associated flexible area 8 be located midway between the two internal clamping means 5.

When two flexible areas 8 are associated with an inner ring 1 having two clamping means 5, these two flexible areas 8 are preferably both symmetrically opposed relative to the longitudinal axis of the sheath and preferably equidistant between the two internal clamping means 5, as in the case shown in FIG. 5.

As can be seen in FIGS. 6 and 7, each flexible area 8 may consist of a material bridge 9 axially connecting two outer rings 2 and itself connected by two side flanges 10 to the inner ring 1 comprising the one or more internal clamping means 5, the inner ring 1 then being preferably broken between the two side flanges 10.

As can be seen better in FIG. 4, other flexible areas 8 can be provided near the inner ring 1 comprising the clamping means 5; the inner rings 1 to which the side flanges 10 of these other flexible areas are connected do not themselves comprise clamping means.

In FIGS. 6 and 7, the side flanges 10 have a preferred configuration, in that they are inclined in opposite directions relative to each other, because this configuration facilitates release of the sheath and its deformation, but they could be arranged in parallel.

The length of the material bridge 9 is equal to the longitudinal distance between the two outer rings 2 connected.

The width (see FIG. 3) of the material bridge 9 is its perimeter in a plane perpendicular to the longitudinal axis X. In this plane, the straight lines connecting the two lateral ends e1 of the material bridge 9 to the longitudinal axis X may form an angle β of preferably between 5 and 20 degrees and in particular approximately 10 degrees.

As can be seen in FIG. 4, the length of the side flanges 10 is equal to that of the material bridge 9 at the outer rings 2 and, if the walls 3 between the rings 1 and 2 are inclined, this length decreases to become equal to the length of the inner rings 1.

The width of the side flanges 10, that is to say the distance between the point where they join the material bridge 9, that is to say the lateral end e1, and the point e2 where they reach the inner ring 1, is a function of their slope, the latter being symbolized by an angle (visible in FIG. 3) defined between a first straight line connecting e1 and the projection of the longitudinal axis X on a plane perpendicular to this axis and a second straight line connecting e1 and e2. This angle γ may be for example from 20 to 40 degrees.

Naturally, the dimensioning of the flexible area(s) 8 is selected according to the deformability required to be imparted to the ringed tubular sheath.

Due to its characteristics, the ringed tubular sheath according to the invention can therefore firmly maintain a smooth tube 11. For this purpose, we compress the flexible area(s) 8 to deform the sheath, introduce the smooth tube 11 in the sheath and then release the flexible area(s) 8 so that the smooth tube 11 is held by the clamping means 5. The firmness of the maintaining of the smooth tube 11 is then determined in particular by the lug 5, particularly by its depth p, by the shape of the top 5a and by the angle α.

Thus, the one or more internal clamping means clamp the tube inside the sheath, that is to say that they apply pressure on it in some way towards the centre of the sheath.

The ringed tubular sheath according to the invention may be of any known type, in particular in one piece and closing on itself to enclose a smooth tube, of the type composed of two shells fitting into one another, of the heart-shaped type or of the type consisting of two shells connected by a hinge so that one of the shells can overlap the other to close the sheath.

Preferably, however, the tubular sheath according to the invention is not split or open longitudinally (axially); it therefore normally comprises only two openings located at is axial ends. The tube 11 can therefore be inserted in the sheath by either of these axial ends.

It goes without saying that the internal clamping means 5 and the flexible area 8 can take many forms similar or dissimilar to those drawn in the appended figures.

The ringed tubular sheath according to the invention is generally made essentially of one or more polymeric materials, preferably thermoplastic.

The invention applies to the maintaining of a ringed tubular sheath on a smooth tube, but it is naturally also suitable for maintaining a ringed tubular sheath on a tube which is not completely smooth or presents a certain roughness or surface irregularities or even moderate or localised variations in diameter.

Its manufacturing process may be a conventional method suitable for the invention, namely a method in which one uses a mould having one or more counter-forms corresponding to the one or more internal clamping means 5,6 and, where appropriate, one or more counter forms corresponding to the flexible area(s) 8.

1. Ringed tubular sheath comprising:
two internal clamping means (5) arranged symmetrically opposite with respect to the longitudinal axis (X) of the sheath;
at least one flexible area (8) associated with one internal clamping means (5), said flexible area(s) (8) being located at an equal distance between the two internal clamping means (5).

2. Ringed tubular sheath according to claim 1, wherein the internal clamping means (5) is constituted by at least one inner ring part (1) forming a protuberance (5).

3. Ringed tubular sheath according to claim 2, wherein the depth (p) of the protuberance (5) is between 30% and 70% of the difference (d) between the distance (R1) between the outer ring (2) and the longitudinal axis (X) of the sheath and the distance (R2) between the inner ring (1) and the same axis (X).

4. Tubular sheath according to claim 2, wherein the angle (α) formed between the straight lines connecting the lateral sides (5c) of the protuberance (5) to the longitudinal axis (X) in a plane perpendicular to said axis is between 10 and 90 degrees.

5. Tubular sheath according to claim 2, wherein the depth (p) of the protuberance (5) is between 30% and 70% of the difference (d) between the distance (R1) between the outer ring (2) and the longitudinal axis (X) of the sheath and the distance (R2) between the inner ring (1) and the same axis (X) and wherein the angle (α) formed between the straight lines connecting the lateral sides (5c) of the protuberance (5) to the longitudinal axis (X) in a plane perpendicular to said axis is between 10 to 90 degrees.

6. Ringed tubular sheath according to claim 1, comprising several internal clamping means (5) distributed along the longitudinal axis (X) of the sheath.

7. Ringed tubular sheath according to claim 1, comprising internal clamping means (5) arranged in pairs of internal clamping means (5) which are symmetrically opposed with respect to the longitudinal axis (X) of the sheath, these pairs of internal clamping means (5) being distributed along the longitudinal axis (X)f of the sheath.

8. Ringed tubular sheath according to claim 1, comprising two flexible areas (8) symmetrically opposite with respect to the longitudinal axis (X) of the sheath and located at equal distance between the two internal clamping means (5).

9. Ringed tubular sheath according to claim 1, wherein the flexible area(s) (8) is (are) constituted by a material bridge (9) axially connecting two outer rings (2) and itself connected by two side flanges (10) to the inner ring (1) comprising the one or more internal clamping means (5, 6).

10. Ringed tubular sheath according to claim 1, comprising two flexible areas (8) symmetrically opposite with respect to the longitudinal axis (X) of the sheath and located at equal distance between the two internal clamping means (5) and wherein the flexible area(s) (8) is (are) constituted by a material bridge (9) axially connecting two outer rings (2) and itself connected by two side flanges (10) to the inner ring (1) comprising the one or more internal clamping means (5, 6).

11. Ringed tubular sheath according to claim 10, wherein the straight lines connecting each of the two lateral ends (e1) of the material bridge (9) to the longitudinal axis (X) form an angle (β) of between 5 and 20 degrees.

12. Ringed tubular sheath according to claim 10, wherein the side flanges (10) are inclined at an angle (γ) defined in a plane perpendicular to the longitudinal axis (X), between
a first straight line connecting the point (e1) where the side flanges (10) join the material bridge (9) and the axis (X) and
a second straight line connecting (e1) and the point (e2) where the side flanges (10) reach the inner ring (1);
this angle (γ) being between 20 and 40 degrees.

13. Ringed tubular sheath according to claim 1, comprising three or five flexible areas (8) symmetrically distributed axially on either side of the one or more internal clamping means (5).

14. Ringed tubular sheath according to claim 1, this sheath being a sheath which is not split axially.

15. Method for manufacturing a ringed tubular sheath according to claim 1, wherein a mould is used comprising one or more counter-forms (7) corresponding to the one or more internal clamping means (5).

16. Method for manufacturing a ringed tubular sheath according to claim 15, wherein the mould further comprises one or more counter-forms corresponding to the flexible area(s).

17. Method for manufacturing a ringed tubular sheath according to claim 1, wherein a mould is used comprising one or more counter-forms (7) corresponding to the one or more internal clamping means (5) and wherein the mould further comprises one or more counter-forms corresponding to the flexible area(s).

18. Method of maintaining a ringed tubular sheath on a tube (11), wherein:
a ringed tubular sheath according to claim 1 is used;
pressure is exerted on the flexible area(s) (8) to deform the sheath;
the tube (11) is inserted in the ringed tubular sheath, and then
the flexible area(s) is (are) released.
